(19) United States
(12) Patent Application Publication
(10) Pub. No.: US 2008/0233011 A1
(43) Pub. Date: Sep. 25, 2008

(54) MICROFLUIDIC DEVICES

(75) Inventors: Douglas B. Gundel, Cedar Park, TX (US); David C. Lueneburg, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/690,652

(22) Filed: Mar. 23, 2007

(51) Int. Cl. B01L 3/00; B32B 9/04

(52) U.S. Cl. 422/99; 156/273.3; 428/411.1

(57) ABSTRACT

A microfluidic device having a first semi-crystalline polymer film with an amorphous or quasi-amorphous surface adhered to an amorphous or quasi-amorphous surface of a second semi-crystalline polymer film. The first semi-crystalline polymer film may also be adhered in part to a conductive layer.

### BACKGROUND

Microfluidic devices are poised to replace macro fluid handling devices in the medical and biotechnology areas for various reasons including: parallel processing, faster analysis, reduced reagent and sample size, and generally lower cost. Associated applications have enormous potential including high throughput screening, genomics, proteomics and in-vitro diagnostics. Often the microfluidics need to be integrated with an electrode for moving and separating fluids or for electrochemical analysis/detection. One common example of a microfluidic device with a current large market is capillary-filled glucose sensor strips in which the blood is pulled to the sensor location where it is analyzed electrochemically to determine the glucose content.

### SUMMARY

One aspect of the present invention provides an article comprising a microfluidic device comprising a first semi-crystalline polymer film having a first amorphous or quasi-amorphous surface, wherein at least a portion of its first surface is adhered to a first conductive layer and at least another portion of its first surface is adhered to a first surface of a second amorphous or semi-amorphous surface of a second semi-crystalline polymer film.

Another aspect of the present invention provides an article comprising a microfluidic device comprising a first semi-crystalline polymer film having a first amorphous or semi-amorphous surface, wherein at least a portion of its first surface is adhered to a first surface of a second amorphous or quasi-amorphous surface of a second semi-crystalline polymer film, the second semi-crystalline polymer film having a recess extending from its first surface to its second surface, and at least a portion of a first conductive layer adjacent the second surface of the semi-crystalline polymer film.

Another aspect of the present invention provides a method comprising providing a first semi-crystalline polymer film; exposing at least a first surface of the first semi-crystalline polymer film to UV radiation to modify its state to an amorphous or semi-amorphous state; providing a second semi-crystalline polymer film having a patterned conductive layer on its first surface; exposing at least a first surface of the second semi-crystalline polymer film to UV radiation to modify its state to an amorphous or quasi-amorphous state; and adhering at least a portion of the modified first surface of the first semi-crystalline polymer film to the patterned conductive layer and at least another portion of the modified first surface of the first semi-crystalline polymer film to the first surface of the second semi-crystalline polymer film.

At least one embodiment of the present invention involves forming a quasi-amorphous layer on the surface of a semicrystalline polymer film and bonding this layer to a similarly altered polymer film that has thin metal traces patterned on its surface. The quasi-amorphous layer bonds sufficiently to the metal traces to be usable in microfluidic devices. The bonding may be accomplished at a lower temperature than needed for an unaltered semicrystalline surface.

An advantage of at least one embodiment of the present invention is that a microfluidic device with a polymer substrate allows high volume low cost manufacturing.

An advantage of at least one embodiment of the present invention is that it allows a feasible and cost-effective method of electrode formation, configuration and integration in a microfluidic device.

An advantage of at least one embodiment of the present invention is that it allows hermeticity of circuits within a microfluidic device or package.

An advantage of at least one embodiment of the present invention is that it allows electrical interconnection to integrated circuits either on board or off board by combining a flexible circuit with features of a microfluidic device.

An advantage of at least one embodiment of the present invention is that it allows two polymer layers to be bonded without the use of an adhesive. This provides such benefits as eliminating the possibility of contaminating a reactive surface in a microfluidic device with an adhesive, eliminating the need to pattern an adhesive layer, and having uniform material compositions around a microfluidic channel instead of an adhesive on one side.

### BRIEF DESCRIPTION OF THE FIGURES

FIG. 1 illustrates a perspective view of an exemplary microfluidic device of the present invention.

FIGS. 2A-2C illustrate cross-sectional views of exemplary microfluidic devices of the present invention.

FIGS. 3A-3G illustrate process steps of an exemplary method of the present invention for making a fluidic device of the present invention.

FIGS. 4A-4H illustrate process steps of an exemplary method of the present invention for making a fluidic device of the present invention.

FIGS. 5A-5J illustrate process steps of an exemplary method of the present invention for making a fluidic device of the present invention.

FIGS. 6A-6C illustrate batch and roll-to-roll process steps of exemplary methods of the present invention for making fluidic devices of the present invention.

### DETAILED DESCRIPTION

Articles having channels and electric circuits provide a way to introduce microfluidic elements into electronic packages. It is conceivable to use micro-electromechanical systems (MEMS) devices, connected through the electric circuits, to analyze chemical fluids and analytes flowing through the channels formed in the circuit substrate. An analytical device of this type could provide channels of controlled depth on the same substrate as the electrical circuit.

Finding compatible processing options that cost-effectively produce precise electrodes sealed into channels is difficult. It is generally preferred that the electrodes touch the liquid in the channel, the electrode surface is inert (e.g., gold), the electrode has a precise area (e.g., amperometric electrodes), the liquid does not leak out of the channel around the electrodes, and the electrodes are placed in the correct location within the channel. There are many available methods for creating channels in a polymeric film including embossing, injection molding, laser ablation, reactive ion etching (plasma), and rotary die cutting. Methods of patterning conductors on polymer films include screen-printing of conductive inks, photolithography (followed by metal etching), and laser ablation of thin metals.

The channels are typically formed on one substrate and the electrodes formed on another substrate. The two substrates are then bonded to each other by some means. The electrodes may extend parallel, or perpendicular, to the channel.

The bonding can be accomplished by direct sealing of polymers by heating them to near their Tg (glass transition temperature), placing them against each other, and applying pressure. Alternatively, the bonding can be accomplished by adhering the polymer layers together, e.g., using a thermoplastic adhesive, a pressure sensitive (PSA), a thermoset adhesive, or a combination thereof Although the direct-sealing method of bonding the polymers together avoids the potential contamination by the adhesive and provides a uniform interface on all sides of the channel, the high pressures and temperatures needed for direct sealing of many polymer films in a short time (to reduce cost) can cause distortion of the channels. Additionally, the polymer film containing the channel(s) must also seal to the metal layer on the opposing to prevent the liquid from escaping the channel.

According to an aspect of the present invention, semi-crystalline polymer films that will be bonded to form a microfluidic device are surface-treated with a pulsed UV light as described in U.S. Pat. No. 5,032,209. This treatment forms a quasi-amorphous surface layer on the semi-crystalline polymer films. The quasi-amorphous polymer structure is easier to heat bond to other materials than the semi-crystalline polymer structure. In particular, the quasi-amorphous surface bonds well to other quasi-amorphous polymeric surfaces. Additionally, it has been found that the quasi-amorphous polymer structure bonds to metal surfaces better than the semi-crystalline polymer structure. This quasi-amorphous polymer-metal bonding has been found to be sufficient to inhibit aqueous penetration along the quasi-amorphous polymer-metal interface. This characteristic is beneficial in articles such as microfluidic devices where aqueous solutions need to be contained.

Because the quasi-amorphous polymer structure bonds to other quasi-amorphous polymer structure and to metal surfaces better than the semi-crystalline polymer structure, a heat-sealing process may be carried out at lower temperatures than are required for standard direct bonding. This ability to use a lower bonding temperature provides an adequate seal between the electrodes and polymer without extensive polymer deformation and channel distortion. Moreover, this process can be accomplished in roll-to-roll process, which can increase production efficiency.

Suitable semicrystalline substrates include polyethylene terephthalates (PET), polyethylene naphthalate (PEN), polyolefins, and liquid crystal polymers (LCP).

Typical microfluidic devices have channels with widths between about 10 and about 200 micrometers, more typically between about 15 and about 100 micrometers, and depths between about 10 and about 70 micrometers. The challenge of integrating microelectronics and fluids in a concise manufacturable “package” is one of the primary obstacles to commercial success in this field. A suitable package may be rigid or flexible. A rigid package may include a flexible circuit with one or more rigidizing layers. One of the key benefits of flexible circuits is their application as connectors in small electronic devices such as portable electronics where there is only limited space for connector routing. It will be appreciated that reduction in thickness of flexible circuits or portions of flexible circuits will lead to greater circuit flexibility as well as allowing inclusion of new features into flexible electrical interconnects. This increases versatility in the use of flexible circuits particularly if the reduction in thickness of the dielectric substrate provides a means of manipulating fluids within the substrate.

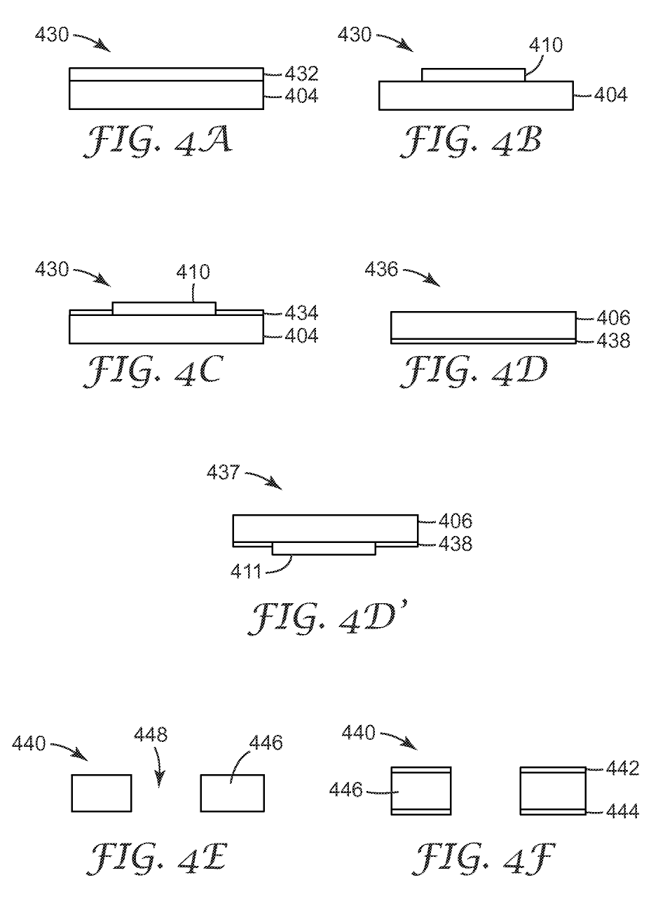

If desired, a cap layer may be attached to the microfluidic device to cover any openings or exposed channels, such as the openings shown in FIG. 3. The cap layer may be a semi-crystalline polymer film, a thermoplastic film, a tape, or an adhesive layer that has been laminated or adhered to a surface of the semi-crystalline polymer film of the microfluidic device. The cap layer may be continuous or may have openings through its thickness. The cap layer may have a conductive layer on a surface or embedded in it.

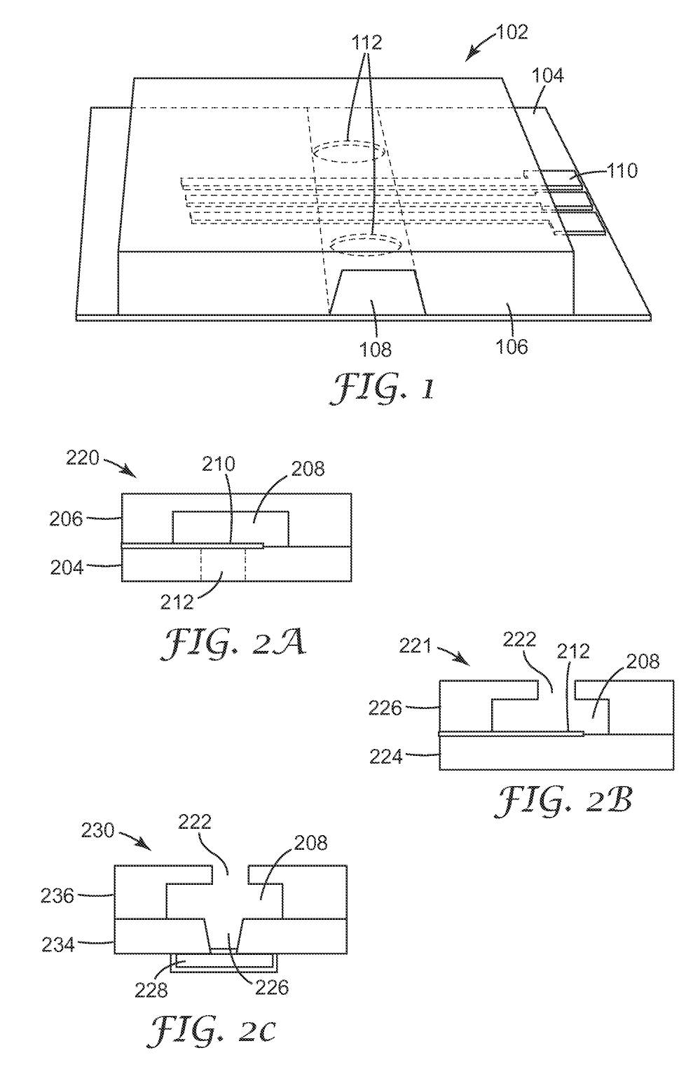

The general layout of the fundamental building blocks of microfluidic devices includes electrodes, contacts, channels, and input-output ports, and optionally wells, reservoirs, and other functional structures. The channels may be closed on the end or left open to allow transport of fluid into the channel. The channel, an optional lid, the base and electrodes/contacts are typically planar and occupy different planes of the microfluidic device construction. FIG. 1 shows a perspective view of an exemplary microfluidic device 102 suitable for use with the present invention. Microfluidic device 102 includes a polymeric base substrate 104 and polymeric top substrate 106. Top substrate 106 include channel (or reservoir) 108 through which a liquid, such as an analyte, flows. Base substrate 104 includes electrodes (or contacts) 110 on its top surface and openings 112, through which liquid enters and leaves channel 108.

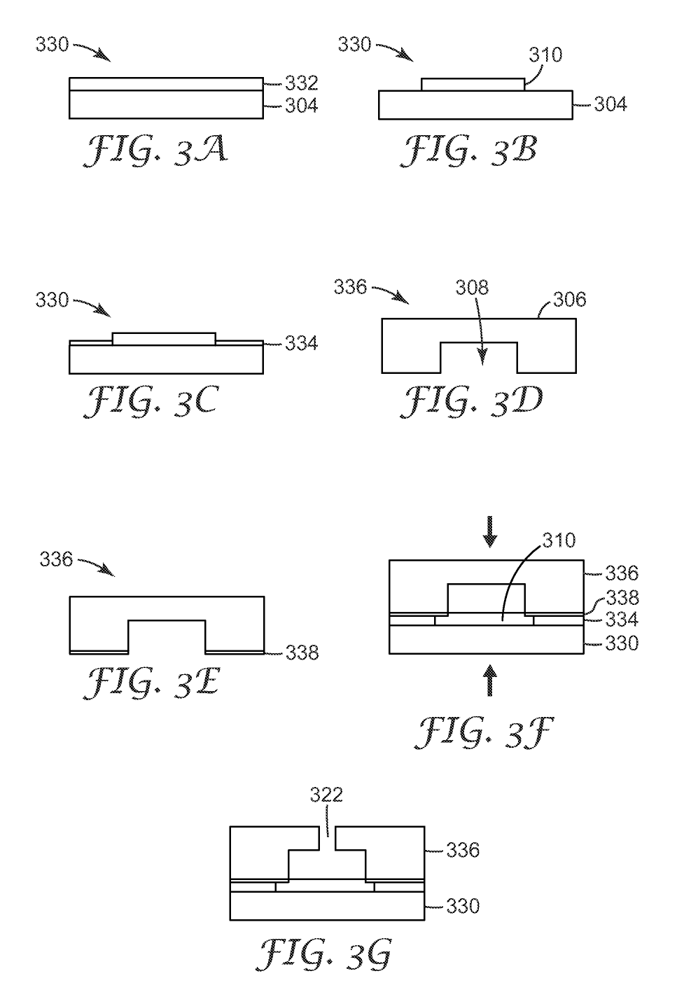

FIGS. 2A-2C show cross-sections of various microfluidic devices. FIG. 2A illustrates a microfluidic device 220, which is similar to microfluidic device 102 of FIG. 1. Microfluidic device 220 includes a polymeric base substrate 204, which has electrode (contact) 210 and opening 212. It further includes polymeric top substrate 206, which has channel (or reservoir) 208. The channel in the top substrate may be formed by methods known to those skilled in the art, such as die cutting, punching, chemical milling, plasma milling, laser ablation, etc. Microfluidic device 221 of FIG. 2B is similar to microfluidic device 220 except that top substrate 226 includes an opening 222 and base substrate 224 does not have any opening. Microfluidic device 230 of FIG. 2C includes a top substrate 236 having opening 222 and channel (or reservoir) 208. Instead of base substrate 234 having an electrode or contact on its top surface, it includes electrode aperture 226, which provides access to electrode (or contact) 228 located on the bottom surface of base substrate 234.

FIGS. 3A-3G illustrate the process steps of a method of the present invention for making a microfluidic device. FIG. 3A shows a base structure 330 which includes thin layer (about 25 to about 150 nanometers (nm) of metal 332 on base substrate 304. Base substrate 304 is a semicrystalline polymeric material. FIG. 3B shows electrode (or contact) 310, on base substrate 304, which has been formed by patterning metal layer 332. Patterning may be done by methods known to one skilled in the art such as laser ablation, chemical etching, etc. FIG. 3C shows base structure 330 after the top surface of base substrate 304 has been treated with pulsed ultraviolet (UV) light. The pulsed UV light forms a quasi-amorphous region 334 on the surface of base substrate 304. FIG. 3D shows top structure 336, which includes top substrate 306 having channel 308. The channel may be formed by any suitable method known to one of skill in the art such as shear cutting, rotary die cutting, chemical etching, etc. FIG. 3E shows top structure 336 after the bottom surface of top substrate 306 has been treated with pulsed ultraviolet (UV) light. The pulsed UV light forms a quasi-amorphous region 338 on the surface of top substrate 306. FIG. 3F shows base structure 330 and top structure 336 registered with each other such that quasi-amorphous region 338 contacts at least a portion of electrode 310 and contacts at least a portion of quasi-amorphous region 334. The two structures are then bonded together, e.g., by laminating at an elevated temperature (i.e., above ambient temperatures, but at temperatures below those required for standard polymer bonding processes). For example, PET would typically be laminated at about 126° C. FIG. 3G shows the bonded structures after opening 322 has been formed in top substrate 336. Alternatively, an opening could be formed in base substrate 304. The opening may be formed by methods known to those skilled in the art such as laser ablation, mechanical drilling, punching, chemical milling, etc. Opening 322 may optionally be formed before structures 330 and 336 are bonded.

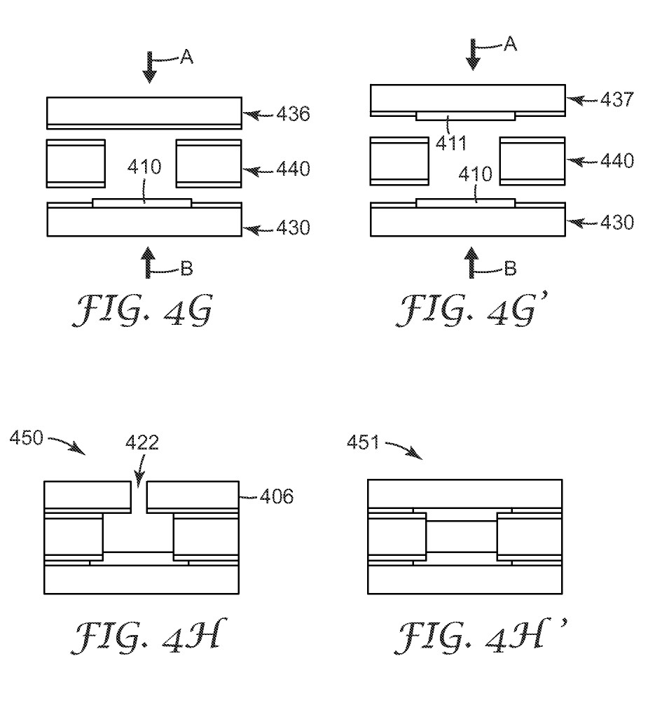

FIGS. 4A-4H show another embodiment of the present invention in which three layers of polymer are bonded to form a microfluidic device. FIG. 4A shows a base structure 430 which includes thin layer (about 25 to about 150 nanometers (nm) of metal 432 on base substrate 404. Base substrate 404 is a semi-crystalline polymeric material. FIG. 4B shows electrode (or contact) 410, on base substrate 404, which has been formed by patterning metal layer 432. Patterning may be done by methods known to one skilled in the art such as laser ablation, chemical etching, etc. FIG. 4C shows base structure 430 after the top surface of base substrate 404 has been treated with pulsed ultraviolet (UV) light. The pulsed UV light forms a quasi-amorphous region 434 on the surface of base substrate 404. FIG. 4D shows top structure 436 (which may be a cap layer) after the bottom surface of top substrate 406 has been treated with pulsed ultraviolet (UV) light. The pulsed UV light forms a quasi-amorphous region 438 on the surface of top substrate 406. FIG. 4E shows middle structure 440, which include middle substrate 446 having channel 448. FIG. 4F shows middle structure 440 after the top and bottom surfaces of middle substrate 446 have been treated with pulsed ultraviolet (UV) light to create quasi-amorphous regions 442 and 444 on the top and bottom surface, respectively, of middle substrate 446. FIG. 4G shows base structure 430, middle structure 440, and top structure 436 registered with each other such that quasi-amorphous region 438 on top substrate 406 contacts at least a portion of quasi-amorphous region 442 on middle substrate 446 and quasi-amorphous region 444 on middle substrate 446 contacts at least a portion of electrode 410 and contacts at least a portion of quasi-amorphous region 434 on base substrate 404. The three structures are then bonded together. Alternatively, middle structure could be first bonded to one of base structure 430 or top structure 436, then subsequently bonded to the remaining bottom or top structure. FIG. 4H shows structure 450 which includes the bonded structures after opening 422 has been formed in top substrate 406.

Another embodiment is similar to 4A-4H except that 4D, 4G, and 4H are substituted with 4D′, 4G′, and 4H′, respectively. In this embodiment top structure (cap layer) 437 is made in a manner similar to that of base structure 430 such that it includes an electrode 411 on the same surface as the quasi-amorphous region 438. In this embodiment, when the base, middle and top structures are bonded together, structure 451 is formed and includes a channel having electrodes on its top and bottom surfaces. Opening 422 may be formed in a portion of the channel at which an electrode is not located.

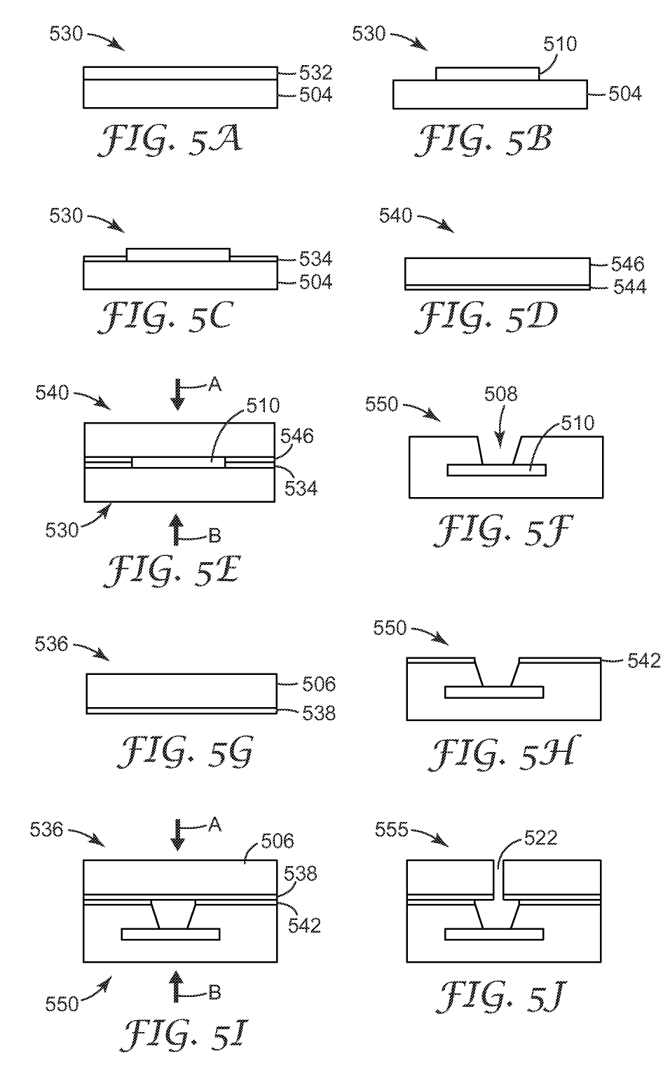

FIGS. 5A-5J show another embodiment of the present invention in which three layers of polymer are bonded to form a microfluidic device. FIG. 5A shows a base structure 530 which includes a thin layer (about 25 to about 150 nanometers (nm) of metal 532 on base substrate 504. Base substrate 504 is a semicrystalline polymeric material. FIG. 5B shows electrode (or contact) 510, on base substrate 504, which has been formed by patterning metal layer 532. Patterning may be done by methods known to one skilled in the art such as laser ablation, chemical etching, etc. FIG. 5C shows base structure 530 after the top surface of base substrate 504 has been treated with pulsed ultraviolet (UV) light. The pulsed UV light forms a quasi-amorphous region 534 on the top surface of base substrate 504. FIG. 5D shows middle structure 540 after the bottom surface of middle substrate 546 has been treated with pulsed ultraviolet (UV) light. The pulsed UV light forms a quasi-amorphous region 544 on the bottom surface of middle substrate 546. FIG. 5E shows base structure 530 and middle structure 540 contacting (but not necessarily registered) with each other such that quasi-amorphous region 544 contacts at least a portion of electrode 510 and contacts at least a portion of quasi-amorphous region 534. The two structures are then bonded together, e.g., by laminating at an elevated temperature to form composite structure 550. FIG. 5F shows composite structure 550 after channel 508 has been formed. Channel 508 provides access to electrode/contact 510. FIG. 5G shows top structure 536 after the bottom surface of top substrate 506 has been treated with pulsed ultraviolet (UV) light. The pulsed UV light forms a quasi-amorphous region 538 on the surface of top substrate 506. FIG. 5H shows composite structure 550 after its top surface has been treated with pulsed ultraviolet (UV) light to form quasi-amorphous region 542. FIG. 5 shows composite structure 550 registered with top structure 536 such that quasi-amorphous region 538 on top substrate 506 contacts at least a portion of quasi-amorphous region 542 on composite structure 550. The two structures are then bonded together. FIG. 5J shows the final bonded structure 555 after opening 522 has been formed in top substrate 506.

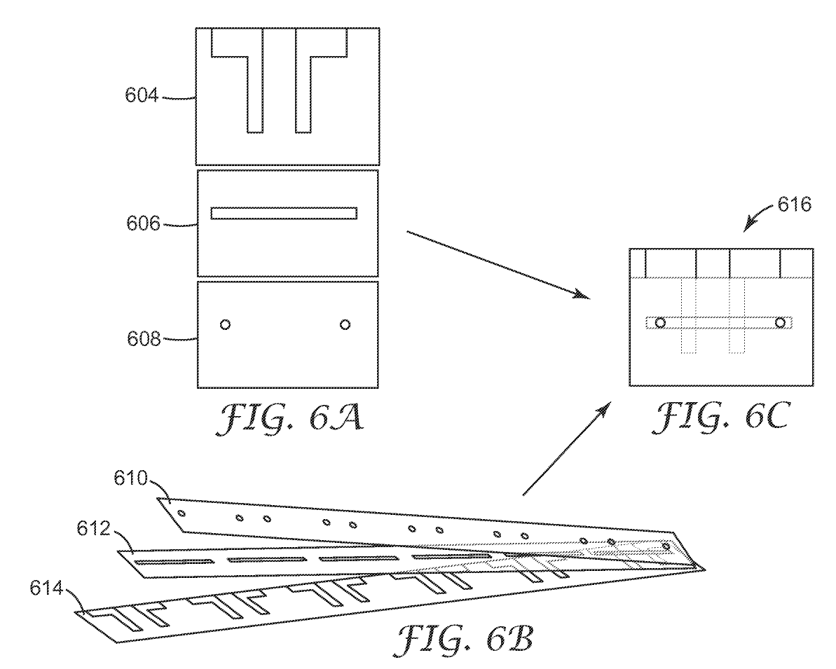

The bonding step can be done as a batch process or can be done as a reel-to-reel process. For either a batch process or a reel-to-reel process, the various substrates are first prepared individually as represented in FIG. 6A and 6B. FIG. 6A shows single base layer 604, channel layer 606, and cap layer 608. FIG. 6B shows continuous film layers with multiple patterns of the base layer 604 (shown as 614), channel layer 606 (shown as 612), and cap layer 608 (shown as 610) for identical microfluidic device. In either case, the individual layers are brought together and heat sealed. FIG. 6C shows the finished microfluidic device. The construction of the microfluidic devices shown in FIGS. 6A-6C is similar to the device made according to the method shown in FIGS. 4A-4H, except that opening 422 is formed in top layer 406 prior to bonding. Examples of other microfluidic devices that can be made in this manner are described in co-pending U.S. patent application Ser. Nos. 10/702827 and 10/702828.

### EXAMPLE

A base substrate of 10 mil (0.254 millimeters (mm)) polyester film available under the trade designation MYLAR A from DuPont Teijin, China, was sputtered with a 50 nm gold layer. The gold layer was patterned into a circuit by a photolithographic method in which tri-iodide based gold etchant was used. After the residual photoresist was removed, the base substrate was flash lamp treated on the circuit patterned side only. The pulsed xenon arc lamp flashlamp operated at 24.4 kV (10 joule per inch input energy to flashlamp) and was operated at 3 pulses per second (pps) with a 1.8 inch (46 mm) aperture. The flashlamp put out about 160 millijoules/cm2. The process was performed reel-to-reel and the continuous sheet of circuit-patterned base material was moved past the flashlamp at a rate of 16.4 feet per minute (fpm) (5.0 meter per minute (mpm)) resulting in 1.65 pulses per substrate area.

A top substrate of 3.88 mil (0.099 mm) polyethylene terephthalate (PET) had no surface coatings and no slip agents. Its bottom surface was flashlamp treated in the same manner as the circuit patterned side of the base substrate.

The middle substrate of 5 mil (0.127 mm) polyester film available under the trade designation MYLAR A from DuPont Teijin, China, was patterned with channels about 1 mm wide by simple shear-cutting. After the residual photoresist was removed, both surfaces of the middle substrate were flash lamp treated in the same manner as the circuit patterned side of the base substrate.

The three substrates were then bonded together simultaneously using a reel-to-reel process. The three layers were brought into contact with each other between 3 inch (76.2 mm) diameter rubber rollers, which applied a pressure of 70 psi (4.9 kg/cm²) to the substrates. The bondline temperature, i.e., the temperature of bonding interface, was approximately 275° F. (135° C.) and the continuous sheets of substrates were moved past the rollers at a rate of about 1 fpm (0.30 mpm).

The resulting microfluidic construction was examined under an optical microscope while an aqueous solution (dyed blue) was added to the channel. The liquid readily moved down the channel by capillary action and was not observed to flow laterally along the traces or at to escape at the metal-polymer interface.

It will be appreciated by those of skill in the art that, in light of the present disclosure, changes may be made to the embodiments disclosed herein without departing from the spirit and scope of the present invention.

1. An article comprising:
a microfluidic device comprising a first semi-crystalline polymer film having a first amorphous or quasi-amorphous surface, wherein at least a portion of its first surface is adhered to a first conductive layer and at least another portion of its first surface is adhered to a first surface of a second amorphous or semi-amorphous surface of a second semi-crystalline polymer film.

2. An article according to claim 1 wherein the first semi-crystalline polymer film has a recess in its first surface, which recess is in communication with at least a portion of the conductive layer.

3. An article according to claim 1 wherein the recess is selected from the group consisting of a channel, a reservoir, and a well.

4. An article according to claim 2 wherein the recess extends from the first surface to a second surface of the first semi-crystalline polymer film.

5. An article according to claim 4 wherein the recess is covered by a cap layer having a first surface adjacent the second surface of the first semi-crystalline polymer film.

6. An article according to claim 5 wherein the cap layer has an opening.

7. An article according to claim 2 wherein the portion of the conductive layer adjacent the recess in the first semi-crystalline polymer film comprises one or more electrodes.

8. An article according to claim 5 wherein the cap layer is a semi-crystalline polymer film and its first surface is an amorphous or semi-amorphous surface a portion of which is adhered to a second conductive layer.

9. An article according to claim 8 wherein the first and second conductive layers comprise electrodes.

10. An article according to claim 9 wherein the electrodes are located on opposite sides of the recess.

11. An article according to claim 1 wherein the second semi-crystalline polymer film has a recess in its first surface.

12. An article according to claim 11 wherein the recess extends from the first surface to a second surface of the second semi-crystalline polymer film.

13. An article comprising:
a microfluidic device comprising a first semi-crystalline polymer film having a first amorphous or semi-amorphous surface, wherein at least a portion of its first surface is adhered to a first surface of a second amorphous or quasi-amorphous surface of a second semi-crystalline polymer film, the second semi-crystalline polymer film having a recess extending from its first surface to its second surface, and at least a portion of a first conductive layer adjacent the second surface of the semi-crystalline polymer film.

14. An article according to claim 13 wherein the portion of a first conductive layer adjacent the second surface of the semi-crystalline polymer film comprises an electrode.

15. A method comprising:
providing a first semi-crystalline polymer film;
exposing at least a first surface of the first semi-crystalline polymer film to UV radiation to modify its state to an amorphous or semi-amorphous state;
providing a second semi-crystalline polymer film having a patterned conductive layer on its first surface;
exposing at least a first surface of the second semi-crystalline polymer film to UV radiation to modify its state to an amorphous or quasi-amorphous state; and
adhering at least a portion of the modified first surface of the first semi-crystalline polymer film to the patterned conductive layer and at least another portion of the modified first surface of the first semi-crystalline polymer film to the first surface of the second semi-crystalline polymer film.

16. A method according to claim 15 further comprising forming a recess in the modified first surface adjacent to the patterned conductive layer.

17. A method according to claim 15 wherein the recess is selected from the group consisting of a channel, a reservoir, and a well.

18. A method according to claim 16 wherein the recess extends from the first surface to a second surface of the of the first semi-crystalline polymer film.

19. A method according to claim 16 further comprising covering the second surface of the of the first semi-crystalline polymer film with a cap layer having a first surface adjacent the second surface of the of the first semi-crystalline polymer film.

20. A method according to claim 15 further comprising forming an opening in the cap layer.

21. A method according to claim 20 wherein the portion of conductive material in the recess is etched away.
